(19) United States
(12) Patent Application Publication
(10) Pub. No.: US 2002/0111997 A1
(43) Pub. Date: Aug. 15, 2002

(54) Methods and systems for securing computer software

(76) Inventor: Maurice Herlihy, Brookline, MA (US)

Correspondence Address: NUTTER MCCLENNEN & FISH LLP, ONE INTERNATIONAL PLACE, BOSTON, MA, 02110, US

(21) Appl. No.: 09/843,609

(22) Filed: Apr. 26, 2001

Related U.S. Application Data
(60) Provisional application No. 60/199,934, filed on Apr. 26, 2000.
(60) Provisional application No. 60/199,935, filed on Apr. 26, 2000.
(60) Provisional application No. 60/200,156, filed on Apr. 26, 2000.
(60) Provisional application No. 60/207,560, filed on May 25, 2000.
(60) Provisional application No. 60/207,559, filed on May 25, 2000.

(51) Int. Cl. G06F 15/16

(52) U.S. Cl. 709/203; 705/51

(57) ABSTRACT

A digital data computing method and system for transforming an original set of computer instructions into a process that makes requests and a response generator wherein the process operates normally only if it receives at least asynchronous replies to its requests. The response generator is external to the process and secured against unauthorized use, access, copying and functional analysis. Moreover, the execution speed of the process is not affected by expected time delays of the means for communication. Further, the methods and system provide such that it is computationally hard to determine the response, or to determine the action the process will take after receiving a response. As such, the invention is suitable for controlling access to computer programs for purposes such as enforcing lease agreements, licensing agreements, and the like, including time-sensitive computer programs where execution timing is a consideration.

### CROSS REFERENCE TO RELATED APPLICATIONS

This application claims the benefit of priority of U.S. Provisional applications Ser. Nos. 60/199,934, filed Apr. 26, 2000, entitled “Secure Reactive Software: Managing Fixed-Size Resources”; 60/199,935, filed Apr. 26, 2000, entitled “Secure Reactive Software: Managing Asynchronous Activities”; 60/200,156, filed Apr. 26, 2000, entitled “Secure Reactive Software: Managing Variable-Sizes Resources”; 60/207,560, filed May 25, 2000, entitled “Secure Digital Content Using Leashed Software”; 60/207,559, filed May 25, 2000, entitled “Guaranteeing Fast Access To Leashed Software,” the teachings of all of which are incorporated herein by reference.

### BACKGROUND OF THE INVENTION

The invention pertains to digital data processing and, more particularly, to methods and systems for securing computer software from unauthorized copying, access or use. The invention has application in the sale, licensing and/or leasing of computer programs.

Unauthorized software copying or theft was not an issue of great concern to the developers of early computer programs. These were typically leased for use on a single mainframe computer, with pricing based on the number of users (or “seats”) entitled to simultaneous access via local or remote terminals. Though software could be copied from computer to computer, programs of value were often so large that surreptitious copying or use was difficult and, typically, relatively easy to detect.

With the advent of the personal computer (PC), a different business model emerged. No longer were programs executed on a single computer but, rather, on individual PCs. While some programs are still leased on a per-seat basis, the more common transaction is outright sale with discounts based on numbers of copies sold. This model is flexible enough to accommodate sales to individual sales to private consumers as well as bulk sales to corporations.

Critical to growth of the PC software market is ease of installation. Private consumers and corporate users alike must be able to install software without support from the publisher or technician. Inherent to this, however, is the danger of unauthorized copying. The same technology that works to the benefit of the legitimate software purchaser, notably, “install” disks, network downloads and installation wizards, also works to the benefit of the unauthorized copyist.

While a variety of techniques have been devised to protect against unauthorized copying or use of software, these have often proven too cumbersome for practical use. An object of this invention, accordingly, is to provide improved methods and systems for transforming and executing secured computer software.

A more particular object is to provide such methods and systems as are adapted for use on networked computers and particularly, for example, computers that are “on” the Internet.

Another more particular object is to provide such methods and systems as are adapted for use with business software and game or other entertainment software, alike.

Still another object of the invention is to provide such methods and systems as can be provided at low cost and as consume minimal processing and memory resources.

### SUMMARY OF THE INVENTION

The foregoing are among the objects obtained by the invention, which provides improved methods and apparatus for securing computer software against unauthorized use, access, copying and/or functional analysis (e.g., “reverse engineering”). According to one aspect of the invention, such a method involves executing the software so as to make requests that require at least asynchronous responses for continued normal operation. Those responses are generated external to the software and supplied to it, e.g., via a network connection or otherwise. The software continues normal operation as long as it receives the responses within an expected period—e.g., a period that corresponds to typical latency in responses from the external source —otherwise, the program ceases normal operation.

Further aspects of the invention provide methods as described above in which the process executes on a client device (e.g. a personal computer) and the responses are generated on a server (e.g., operated by the software publisher or at another secured site) which communicates with the client device via a network, such as the Internet. Related aspects provide such methods in which the responses are generated on a coprocessor or other local hardware device that communicates with the protected software via a local bus, for instance.

The invention provides, in still other aspects, methods as described above in which the externally-generated responses are non-deterministic responses and/or otherwise computationally difficult to generate, e.g., without access to source or other programming code underlying the protected software.

Still another aspect of the invention provides methods as described above wherein the protected software performs memory or other resource allocations and wherein continued normal operation depends on at least occasional de-allocations, e.g., to avoid memory or other storage overruns. Such methods include executing requests within the software and utilizing responses to those requests as bases for necessary de-allocations.

Further aspects of the invention provide methods for transforming software to operate as described above and, thereby, to secure it against unauthorized use, access, copying and/or functional analysis..

Still further aspects of the invention provide digital data processing systems operating in accord with the above described methods.

Other aspects of the invention provide systems paralleling the operation described above. These and other aspects of the invention are evident in the drawings, description and claims that follow.

### BRIEF DESCRIPTION OF THE DRAWINGS

A more complete understanding of the invention may be attained by reference to the drawings, in which:

FIG. 1 depicts a transformation according to the invention wherein an original reactive program is transformed into a client program and a server program, each hosted in a client environment and server environment respectively;

FIG. 2 depicts a transformation according to the invention whereby division of allocation and de-allocation functionality is segregated between the client and server programs;

FIG. 3 depicts a stage of the transformation according to the invention whereby over-allocation of dynamic resources is performed;

FIG. 4 depicts a stage of the transformation according to the invention whereby the de-allocation of dynamic resources is performed;

FIG. 5 depicts a method of executing protected software according to the invention wherein the random de-allocation of resources occurs during run-time;

FIG. 6 depicts a stage of the transformation according to the invention whereby the client program includes steganographic calls to the server.

### DETAILED DESCRIPTION OF THE ILLUSTRATED EMBODIMENT

While a variety of different techniques exist for protecting software against unlawful copying and distribution, systems which are considered relatively secure include those in which a original program P is split into two programs, a client program C running at a processor controlled by the client, and a server program S running at a processor controlled by the owner and, typically, not readily accessible to the client. The client and server processors operate in communication. If C and S are executed concurrently, together they realize the functionality of the original P. The client cannot execute P by itself, and it is difficult for the client to reconstruct the functionality of P given C and many instances of the communication between C and S, but not S itself. In this way, the owner can use control over C to prevent unauthorized execution of P.

In some embodiments, the owner controlled processor is a secure co-processor or hardware key attached to the client machine with communication occurring over a local bus (see for example U.S. Pat. No. 5,754,646 issued to Williams). To save in hardware costs, secure co-processors in the commercial market are usually inexpensive devices with limitations on computing speed and memory size.

In other embodiments, the owner-controlled processor is a remote host that communicates with the client host over a network such as the Internet. One system that embodies this approach is described in U.S. Pat. No. 6,009,543, entitled “Secure Software System and Related Techniques,” the teachings of which are incorporated herein by reference.

For many programs, acceptable performance includes the requirement that the program respond to certain inputs within a certain time duration. For brevity, we will call such programs reactive programs. Reactive programs include, but are not limited to, programs such as interactive games, word processors, teleconferencing, financial software, database front-ends, players of video or audio, and any other programs that interact with human users by responding to their commands. Reactive programs also include real-time systems such as process controllers one might find in factories, power plants, automobiles, etc.

A major concern with software-splitting techniques is the latency introduced by communication between the client's processor and the owner's processor. It will be appreciated by those of ordinary skill in the art that one cannot easily split a reactive program P into client and server programs C and S in a way that preserves the reaction time of P.

In a coprocessor embodiment, the coprocessor is likely to be substantially slower than the main processor, and the need to buffer data and to share a system bus with other activities (such as memory access) implies that communication delays can be substantial and unpredictable. Moreover, many secure co-processors have limited memory size, which implies that programs and data must be swapped in and out of memory during computation, further increasing communication delays and uncertainty.

In a network embodiment, network delays can be long or unpredictable, and there are many situations in which it is not effective or acceptable to rely on a network to guarantee timely response to inputs.

In either embodiment, if P is split in such a way that C communicates with S in the interval between receiving an input and generating its response, then the observed reaction time of C may be substantially longer than the reaction time of P, and the performance of the split program would be unacceptable to the client.

The illustrated embodiment provides a technique for controlling the use of reactive programs without rendering the reaction time of such programs unacceptable. To this end, it involves splitting a program P so that there is no real-time dependency of the client program C on the server program S.

More particularly, in the discussion that follows, we describe an embodiment in which an original reactive program P (in source, binary, or any intermediate form) is transformed into two programs, C and S, a first (client) storage device having C stored therein, a second (server) storage device having a server program which utilizes S, and execution processors coupled to the client and server storage devices to execute C and S respectively. With this particular arrangement, a processing system for use with secure reactive software is provided. The system allows the server program to control the execution of the client program C. In one embodiment, the transformation is accomplished by a code transformation processor, a program that receives P and possibly some additional parameters as input, and produces S and C as output. In another embodiment, the transformation is performed directly by a programmer.

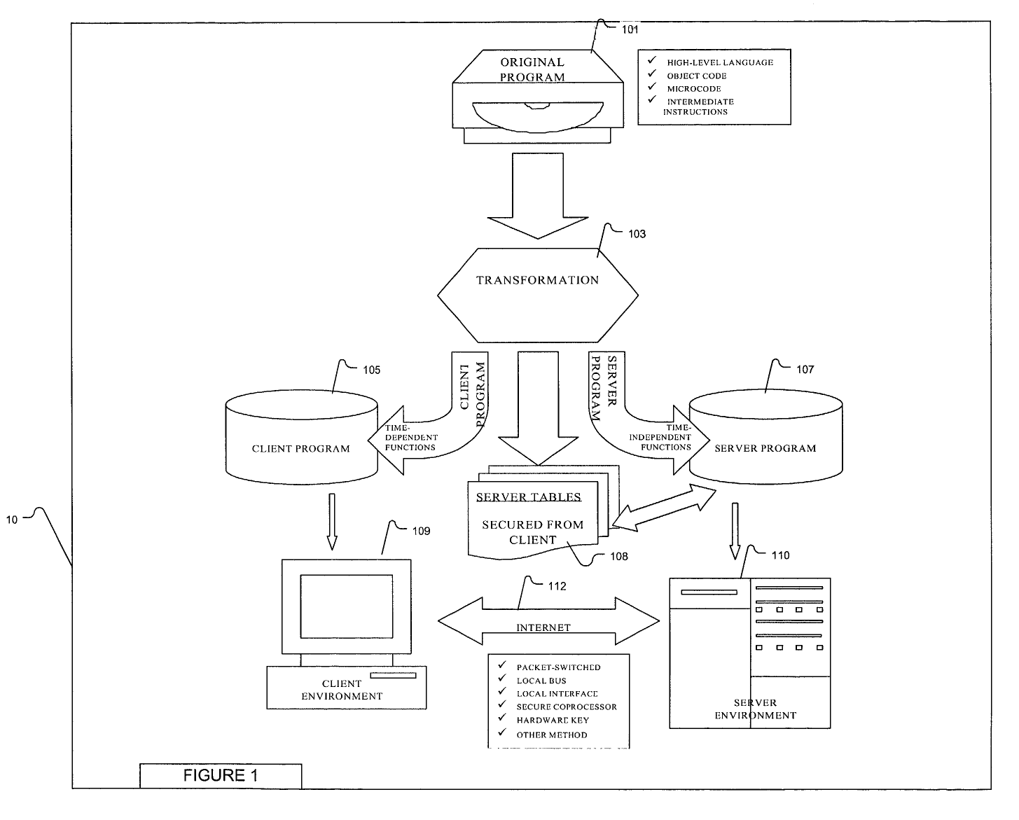

FIG. 1 depicts a system 10 according to the invention that transforms an original program 101 into a client program 105 and a server program 107, and that executes those programs in view of a set of server tables 108 so as to secure the programs 101, 105, 107 from unauthorized use, access, copying and/or functional analysis (e.g., “reverse engineering”).

Illustrated program 101 comprises high level language, object code or other intermediate code, microcode, or other programming instructions to be secured from unauthorized copying, access, use or functional analysis. Though depicted as contained on a CD ROM, it will be appreciated that program 101 can be stored in any known format or on any known medium.

The program 101 is transformed through an automated process (such as by illustrated transformation engine 103) or “by hand” (such as by a computer programmer). The transformation can occur in one or more steps of phases, referred to below as transformation stages one through four that are executed serially (as described) or concurrently with one another. The transformation 103 results in a client program 105, a server program 107 and one or more server tables 108. Those skilled in the art will appreciate that, though the transformation is shown as being effected on an original program 101, in alternate embodiments the client program 105, the server program 107 and server tables 108 can be produced directly (e.g., by the programmer) without need for an original program nor a transformation 103.

Like the original program 101, the client program 105 comprises high level language, object code or other intermediate code, microcode, or other programming instructions. In the illustrated embodiment, the client program 105 is generated in the same form as the original program; however, in other embodiments it can be generated in a different form.

In the illustrated embodiment, the client program 105 is hosted in an environment such as a personal computer 109. In alternate embodiments, it is hosted on any variety of digital data processing devices, from PDAs to video game boards. The client program is transferred to the client device 109 via install disks, downloading, or any other mechanism known in the art for code transfer and installation. Further, when in communication with the server program 107, the client program 105 reacts to inputs in a manner substantially similar as the original program 101 would if hosted in the same environment.

The server program 107 is hosted in a server environment, such as web server 110. However, such hosting can take a variety of well known forms such as taught in U.S. Pat. No. 6,009,543 entitled Secure Software System and Related Techniques by Shavit, or U.S. Pat. No. 5,754,646 entitled Method for Protecting Publicly Distributed Software by Williams et al. As with hosting the client program 105, the server program 107 may be hosted as illustrated on a remote server, or is also suitable for hosting on a secured coprocessor or a client processor with a pre determined set of secure instructions and memory, or other means similar to the client program 105. The server program is transferred to the server device 110 via install disks, downloading, or any other mechanism known in the art for code transfer and installation. The server program 107 generates responses to requests from the client program 105, and communicates the responses using a means for communication 112. Further, the server program 107 from time to time randomly initiates responses without requests in a non-deterministic manner. When the server program 107 receives a request, it determines the proper response by using the data stored within the server tables and data structures 108.

The illustrated communication device 112 is the Internet, but it can be appreciated that a variety of communication techniques may be used such as a local bus, wide or local area networks, or a local interface, to name a few.

Many computer programs encompass tasks that are executed as a sequence of steps such that fall into two groups: active steps that must be executed immediately to preserve the reactive nature of the program, and lazy steps that may be executed at any point within a given duration without jeopardizing the program's reactive properties. The technique described herein splits such activities of the original program 101 between the client process 105 and server program 107 in the following way. In the client program 105, lazy steps of the original program are replaced by requests to the server. These requests are structured in a way that ensures that an observer inspecting the client program and its executions cannot easily reconstruct the original lazy steps. The server program performs the lazy steps and informs the client program when it does so by asynchronous messages.

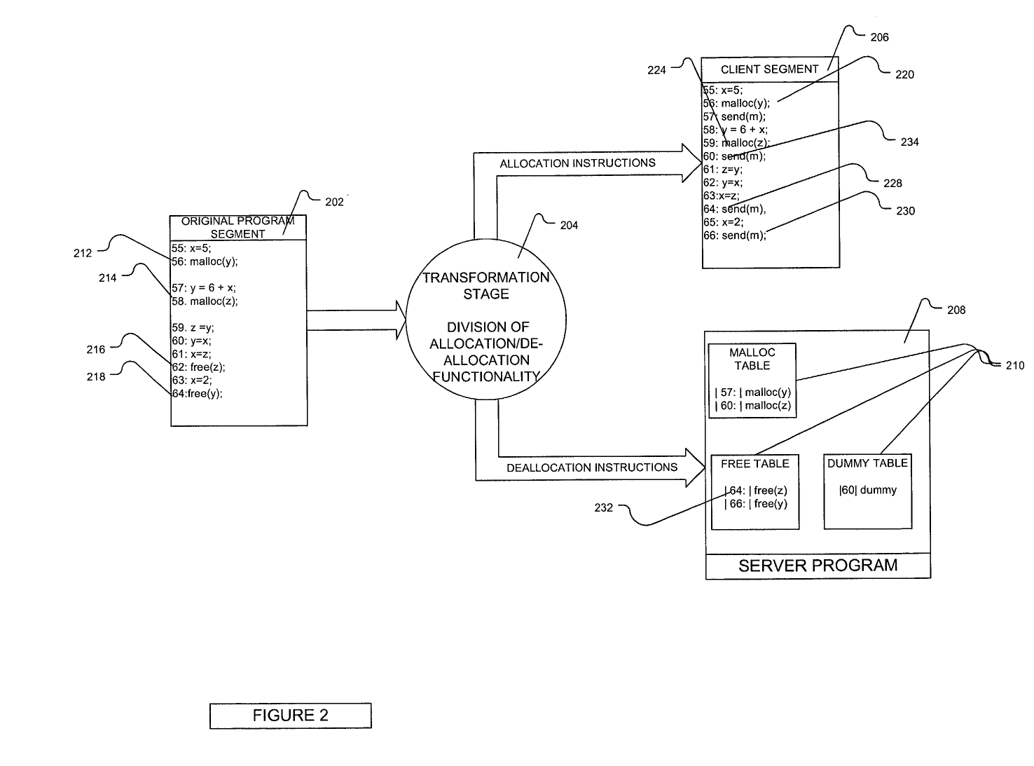

A specific example of tasks comprising active and lazy steps is dynamic memory allocation and de-allocation. FIG. 2 depicts a transformation of such a task wherein an original program segment 202 is transformed by a transformation stage 204, a part of the transformation 102 (FIG. 1), to include requests to the server 208 for data necessary to allocate and de-allocate dynamic memory on device 109. The figure also depicts the generation of the server tables 210 (see, element 108 of FIG. 1) during the transformation.

In studying the text that follows, those skilled in the art will appreciate that a block of memory is a contiguous sequence of one or more bytes in a computing device's primary memory. A block b is characterized by two components:

(1) a starting address b.addr, which is the address of the first byte in the block; and

(2) a size b.size, which is the number of bytes in the block.

A block b is empty if b.size is 0. A byte of memory x is in a block b if the address of x is greater than or equal to b.addr and less than b.addr+b.size. A block c is contained within block b if every byte in c is also in b. A block b can be split into two smaller blocks c and d, where b.addr =c.addr, d.addr=c.addr+c.size, and d.size=b.size−c.size. Similarly, c and d can be merged to form b.

A computer program creates and disposes of data structures within memory blocks as it executes. To support such activity, the program maintains a free-pool of unused memory. To create a data structure of particular size, the program allocates a block of memory large enough to hold the data structure, thereby removing that memory from the free-pool. When the program no longer requires that data structure, it returns the memory block to the free-pool, thus making the memory available for other purposes. Typically, run-time management libraries are used to allocate and de-allocate memory blocks. For example, in the C-language the statement:

obj_ptr=malloc(obj_{—size);}

allocates a block of obj_size bytes, returning the starting address of the block in obj_ptr. Further, the statement:

free(obj_ptr);

returns that block of memory to the free-pool. It will be appreciated by those of ordinary skill in the art that other techniques of memory management can easily be translated to use equivalent methods for the allocation and de-allocation of memory blocks or segments.

Referring to FIG. 2, the transformation stage 204 translates the malloc instructions 212, 214 and free instructions 216, 218 instructions of an original program 202 such that the dynamic allocation/de-allocation instructions are divided between the activities of the client 206 and the server 208 in such way that as long as the client and server remain in communication, the client will allocate and free memory correctly.

For example, the code segment listing that follows corresponds to the original reactive program segment 202 in FIG. 2. The number at the beginning of each line in the listing represents the program counter or other index and the text represents High-Level language:

| | |
|---|---|
| 55: | x=5; |
| 56: | malloc(y); |
| 57: | y=6+x; |
| 58: | malloc(z); |
| 59: | z=y; |
| 60: | y=x; |
| 61: | x=z; |
| 62: | free(z); |
| 63: | x=2; |
| 64: | free(y); |

After the illustrated transformation stage depicted in FIG. 2, the resulting process segment 206 would be:

| | |
|---|---|
| 55: | x=5; |
| 56: | malloc(y); |
| 57: | send(m); |
| 58: | y=6+x; |
| 59: | malloc(z); |
| 60: | send(m); |
| 61: | z=y; |
| 62: | y=x; |
| 63: | send(m); |
| 64: | x=z; |
| 65: | send(m); |
| 66: | x=2; |
| 67: | send(m); |

and the server tables 210 would contain:

| | |
|---|---|
| 57 | malloc(y) |
| 60 | malloc(z) |
| 63 | dummy |
| 65 | free(z) |
| 67 | free(y) |

In this example, from beginning to end, the free instruction 216 in the original program segment 202 is transformed into the send instruction 228 in the client segment 206 and the free table entry 232 in the server table, free_table 208. The look-up index of 64 corresponds to the program counter in the process segment 206 at which the send(m) message request 228 is executed. While the illustrated embodiment references use the program counter as the look-up index into the server table, one skilled in the art can recognize that any random sequence of unique identifiers is applicable to the transformation. Further, it can be noted that the malloc operations 212, 214 in the original program segment 202 are present in the process segment 220, 224. It is not obvious which of the send instructions 228, 234, 230 correspond to which free instruction 216, 218. Furthermore the responses sent from the server program 208 to the client 206 need not be in the same order as the requests from the client 206 to the server program. More specifically, a free corresponding to a given malloc operation cannot be determined without the server table 210. Without knowing where in the code the free messages occur, generating the functionality without analysis of the server table is difficult and could result in either running out of memory or freeing variables that are still in use. The problem of adding new free instructions without knowing the tables can be shown to be NP-Hard.

The transformation also has the capability of over-allocating dynamic resources, and randomly de-allocating the over-allocated portion during run-time such that it is computationally hard to learn the appropriate responses from the communication history. Consider the following operations:

| | |
|---|---|
| s.remove(b) | removes from s all blocks contained in b; |
| s.add(b) | adds b to 5; and |
| s.choose | removes and returns an arbitrary block from s. |

It will be appreciated by one skilled in the art that a set of blocks can be implemented in a variety of ways such as arrays, trees and linked lists to name a few. After transformation by the invention, information about blocks of memory in use is split between the client and the server as follows: the client keeps track of a set of blocks, client_set and the server keeps track of a set of blocks, server_set. Each block in server_set is a sub-block in client set that is not actually used by the client program. One way in which this is accomplished is by over-allocating resources used by the client program. Whether a memory byte is in use by the client can be determined by examining both client set and server_set, but it is computationally hard to determine from the client_set alone.

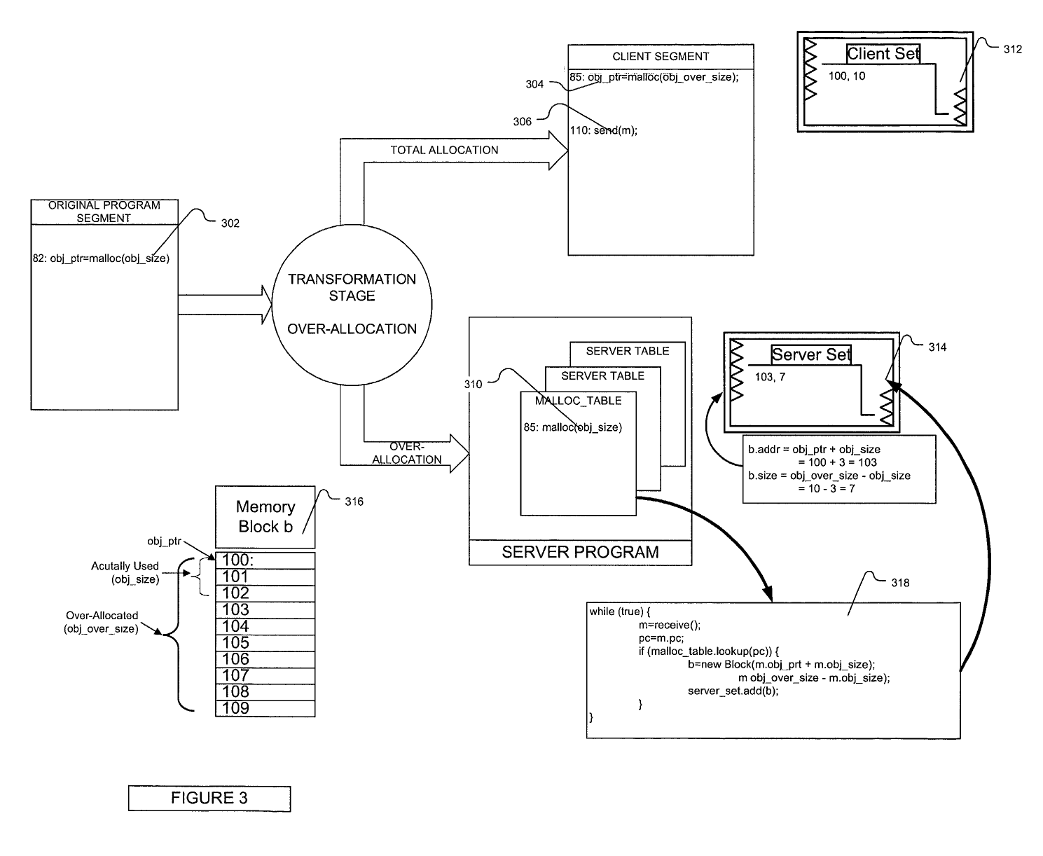

To illustrate this method, consider the following statement at line 82 of the original program segment in FIG. 3:

obj_ptr=malloc(obj_size); 302

where obj_size is a variable containing the size of the object, and obj_ptr is assigned a pointer to the beginning of the object. After the transformation, the client contains:

obj_ptr=malloc(obj_over_size); 304

send(m); 306

where,

obj_over_size≧obj_size;

and m is a message containing at least the current value of C's program counter and the values of some or all of its local variables. This transformation causes C to allocate a block of memory at least large enough to hold the object and then to send a message containing at least its program counter and local variables to S. Note that the send instruction 306 at line 110 need not appear next to the malloc instruction 304 at line 85, but may be separated by some arbitrary or random number of instructions, including other send instructions.

The server program S is initialized with table malloc_table 310 that identifies the program counter (pc) values in C at which memory blocks are allocated. Each time S receives a message containing the current program counter and local variables of C, it looks up pc in malloc_table. If the statement at location pc is a call to malloc, then S reconstructs from the local variables the address of the newly-allocated block (obj_ptr), the size of the block (obj_over_size), and the portion of the block actually in use (obj_size), and adds the block with address obj_ptr+obj_size and size obj_over_size—obj_size to the set server_set. This program is illustrated as follows 318:

while (true) {

m = receive();
pc = m.pc;
if (malloc_table.lookup(pc)) {

b = new block(m.obj_ptr + m.obj_size),

m.obj_over_size − m.obj_size);

server_set.add(b);

}

}

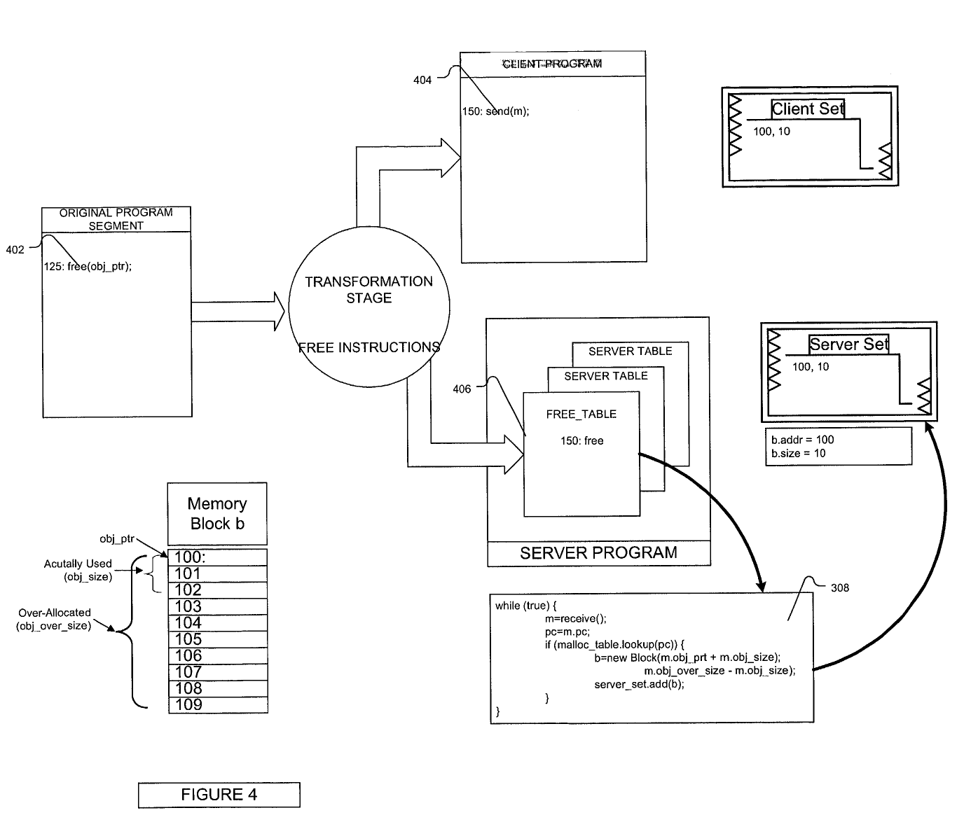

Another stage of the transformation depicted in FIG. 4 shows the transformation of free instructions. The free(obj_ptr) 402 instruction in the original program segment at line 125 is transformed to into a send(m) 404 instruction in the client program as shown at line 150, and an entry is placed in the server table, free_table 406 at position 150 corresponding to the program counter in the client program. When the send(m) instruction 404 is executed from the client location 150, where m contains the program counter and some or all of its local variables, the server performs a look-up in the free_table 406 to determine the proper action to take. If the statement at location pc is a call to free, then S reconstructs from the local variables the address of the block b to be freed. It then adds to server_set every block contained in b. In this way, it is difficult to determine when a free is actually performed without access to the server table. It is not shown in the figure but should be obvious to one skilled in the art that the responses to free instructions need not be in the same order as the requests are received.

The program segment within the server program to implement after this stage of the transformation could be as follows:

while (true) {

m = receive ();
pc = m.pc;
if (malloc_table.lookup(pc)) {

b = new block(m.obj_ptr + m.obj_size,

m.obj_oversize − m.obj_size);

server_set.add(b);

} else if (free_table.lookup(pc)) {

b = new block(m.obj_ptr + m.obj_size,

m.obj_oversize − m.obj_size);

server_set.add(b);

}

}

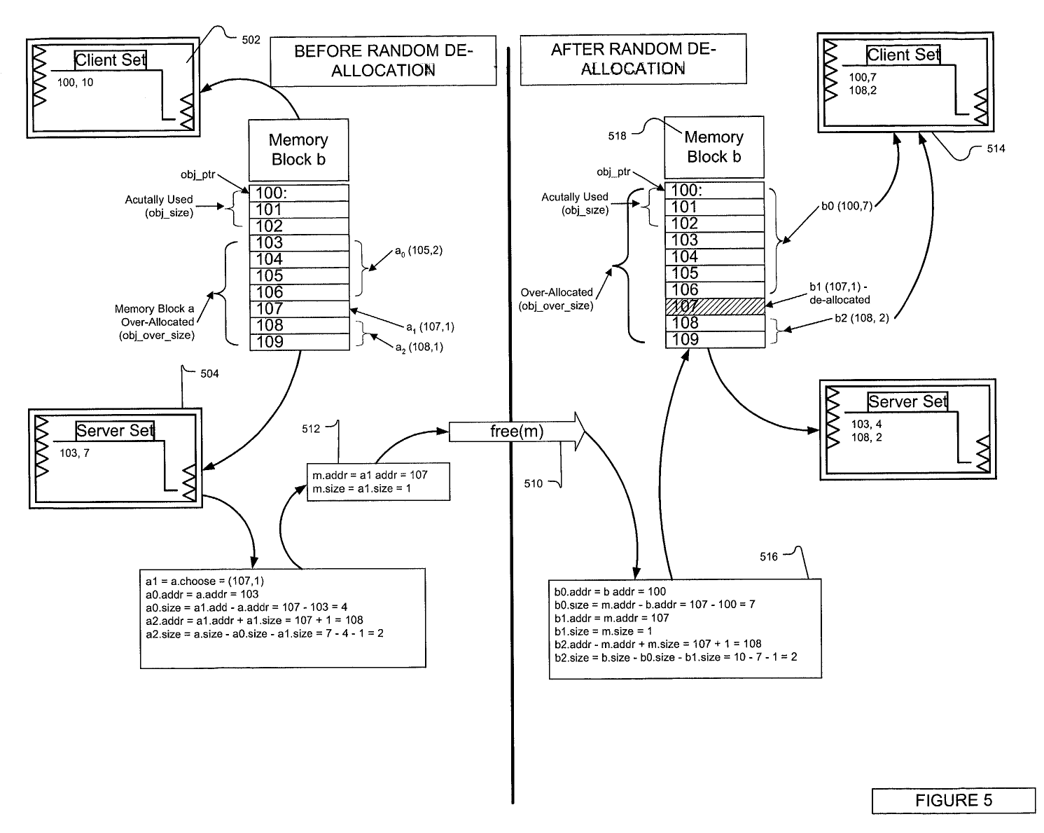

A further stage of the transformation depicted in FIG. 5 allows the server program to periodically remove an arbitrary block of memory during run-time, that is allocated but not actually used by the client program. For example, consider the transformation stages described above using a memory block b 316 (FIG. 3). The server_set 504 represents block a which is the over-allocation portion of block b as described in this illustrated embodiment and above. The server S removes block a from the server_set and splits a arbitrarily into three blocks a₀, a₁ and a₂ where a₀ or a₂ or both may be empty such that if a₀ is not empty it is placed back into the server_set and if a₂ is not empty it is placed also placed back into the server_set. Then S sends a message to C that:

m.addr=a₁.addr;

m.size=a₁.size;

When the client receives the message, it removes from client_set 514 the sub-block b₁ containing m.addr as follows: the client program splits block b 518 into b₀, b₁ and b₂ where 516:

b₀.addr=b.addr;

b₀.size=m.addr−b.addr;

b₁.addr=m.addr

b₁.size=m.size;

b₂.addr=m.addr+m.size; and

b₂.size=b.size−b₀.size−b₁.size.

Further, if b₀ is not empty, the client places b₀ back into client_set 514. Also, if b₂ is not empty, the client places b₂ back into client_set 514. This transformation permits the server to return to the client blocks of memory that were allocated but not actually used. Note that these blocks could be the result of either over-allocations or freed memory which the server knows about via old free messages it received.

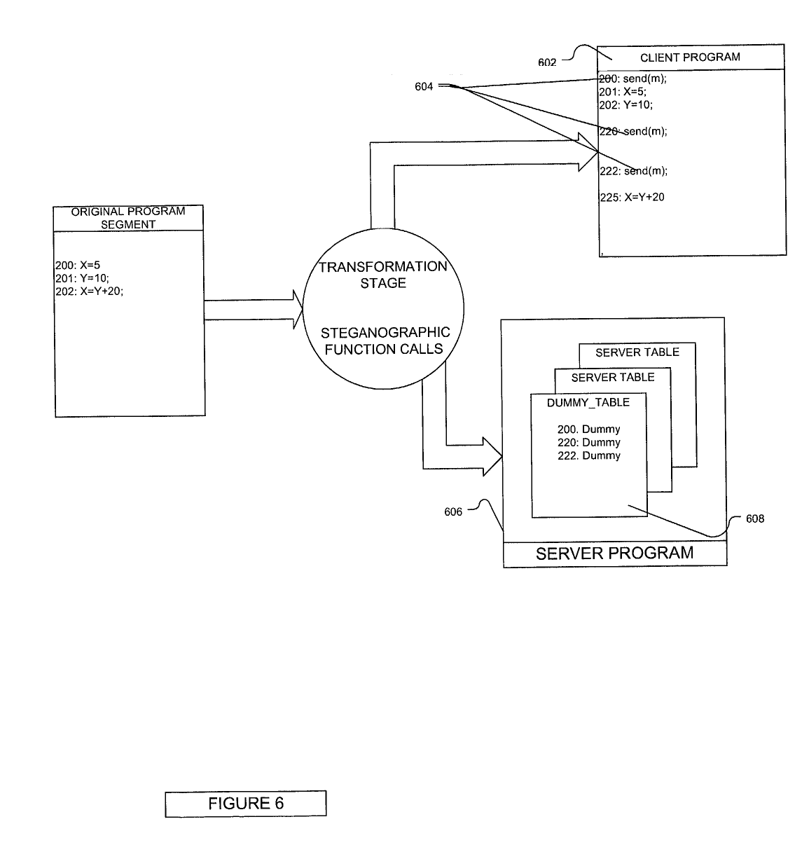

In still another stage of the transformation as depicted in FIG. 6, instructions are placed within the client program 602 comprising:

send(m); 604

instructions, where m is a message containing the current program counter or other index and the value of some or all of the client's local variables. The server 606 maintains a server table dummy_table 608 where the server takes no action if the table entry corresponding to the program counter is a dummy operator. In the illustrated embodiment, these statements are executed frequently enough that analysis of the client would not distinguish among the message transmission statements introduced in the transformation stages as discussed above, and further, analysis of the message traffic between the client and server cannot easily track which subset of the memory in client_set is actually in use. Thus, the message transmission statements introduced in this transformation provide steganographic protection for the message transmission statements introduced in the earlier transformation.

It is appreciated that in some programs there may be a substantial delay between the time at which the program allocates a memory block, and the time that block is first used. Such activity is a lazy allocation, and provides an alternative transformation stage appropriate for lazy allocations. Consider a program P containing a first statement in the form:

obj_ptr=malloc(obj_size);

and a second statement in the form:

initialize(obj_ptr);

which initializes the contents of the block b such that

b.addr=obj_ptr.

The first and second statements may be at different positions in P, and there may be a delay between their executions. An embodiment of the invention provides a sequence of transformation stages for such programs.

First, a stage of the transformation may apply the following transformation to the first statement. The client will allocate a memory block large enough to hold a pointer, initialize that block to hold a special value, and send the current program counter and local variables obj_size, the object size, and future_ptr, the address of the newly-allocated block to the server.

future_ptr=malloc(4);

*future_ptr=null;

Here, it is assumed that four bytes are large enough to hold a pointer, and m is a message containing the current value of client C's program counter and the value of some or all of C's local variables. Notice that after the transformation, the client cannot easily deduce the size of the object from the transformed code.

The server program S is initialized with a table lazy_malloc_table similar to the server tables as described above that identifies the program counter values in C at which lazy allocations occur. Each time S receives a message containing the current program counter value pc and local variables of C, it looks up pc in the lazy_malloc_table. If the statement at location pc is a lazy allocation, then S reconstructs from the local variables the values of obj_size and future_ptr. The server S then removes from server_set a block b of size greater than or equal to obj_size. The server program S splits b into three blocks, b₀, b₁, and b₂, where b₁.size=m.obj_size.

If b₀ is not empty, S places b₀ back into server_set. If b₂ is not empty, S places b₂ back into server_set. The server then sends future_ptr and b₁.addr to the client.

When the client receives b₁.addr from the server, it stores that value in the block whose address is future_ptr.

*future_ptr=b.addr;

The Client's second statement is transformed into two statements: a loop that waits for future_ptr to be initialized by the Server's message, and the initialization of the block;

```
  while (*future_ptr == null) {
  obj_ptr = *future_ptr
  free(future_ptr);
  initialize(obj_ptr);
}
```

In a preferred embodiment, this transformation would be applied to statements such that the delay between executing the first and second statements exceeds the round-trip communication time between the client and the server. In this situation, C will not need to execute the loop statement more than once.

The above discussion has illustrated an embodiment using variable size resources, but programs often manage pools of fixed-size resources. Such resources include but are not limited to disk pages, memory pages, file descriptors, and fixed-size data structures. For brevity, we disclose the invention in terms of disk pages, but it will be appreciated by those of ordinary skill in the art that these techniques can be applied to any fixed-size resource.

A disk page is a contiguous sequence of one or more bytes on a magnetic disk. A page p is characterized by a starting address p.addr, which identifies the page's location on the disk. All disk pages have the same size, denoted here by P. A pool of pages is a data structure that keeps track of a plurality of pages. For each page, the pool determines whether the page is in use (allocated) or not in use (free). A pool provides the following operations. The call

page_addr=pool.allocate();

allocates a page, returning the newly-allocated page's address. The call

pool.free(page_addr);

where page_addr is the address of a page previously allocated by allocate, returns that page to the pool. The call:

pool.mark(page_addr);

marks a specific free page as allocated. The call

page_addr=pool.choose();

returns the address of an arbitrary allocated page (or a distinguished value null if none exists).

Run-time libraries typically provide a variety of more specialized disk page allocation calls, or other calls of equivalent functionality. It will be appreciated by those of ordinary skill in the art that programs that manage disk pages using other techniques can easily be re-written to use a run-time library of equivalent functionality.

The transformation of program P is accomplished as described below. This non-limiting example provides a transformation stage that divides the management of disk pages (or any other fixed-size resource) by P between C and S in such a way that as long as C and S remain in communication, C will allocate and free disk pages correctly. Moreover, C will respond to inputs within the same required duration as P.

In this described embodiment, information about which disk pages are in use is split between the client program C and the server program S as follows. The client program C keeps track of a pool of pages client_pool. The server keeps track of a pool of pages server_pool. Both client_pool and server_pool manage the same set of pages. In the preferred embodiment, each page in client_pool is a page allocated by C, and each page in server_pool is a page allocated by C but not actually in use by C. Whether a page is in use by C can thus be determined by examining both client_pool and server_pool, but cannot necessarily be ascertained from client_pool alone.

For example, consider the following statement of P:

page_addr=allocate();

the statement is transformed into the following two statements in C:

page_addr=allocate();

send_server(m);

Here, m is a message containing the current value of C's program counter, and the value of some or all of C's local variables. This transformation causes C to allocate a disk page and then to send a message containing its program counter and local variables to S. These statements may be executed one right after the other, or they may be separated by other statements.

In a further stage of the transformation, the additional allocation requests to C, could take the form:

page_addr=allocate();

send_server(m);

In a preferred embodiment, these additional allocation requests make it difficult for the client to determine which allocations correspond to allocations in P, and which are introduced by the transformation. As in the first transformation, these statements can be executed one after the other, or they may be separated by other statements. For brevity, we refer to the allocation requests introduced in this transformation as spurious allocations.

The server program S is initialized with a table alloc_table that identifies the program counter values in C at which spurious allocations occur. Each time S receives a message containing the current program counter value pc and local variables of C, it looks up pc in alloc_table. If the statement at location pc is a spurious allocation, then S reconstructs from the local variables the address of the newly-allocated disk page (page_addr), and marks the disk page address page_addr:

server_pool.mark(page_addr);

This program is illustrated as follows:

while (true) {

```
  m = receive();
  pc = m.pc;
  if (alloc_table.lookup(pc))
```

server_pool.mark(m.page_addr);

}

A further stage of the transformation transforms statements in which P frees a disk page previously allocated by allocate:

free(page_addr);

In the client program C, this statement is transformed into a message transmission:

send_server(m);

where m is a message containing the current value of C's program counter and the value of some or all of C's local variables.

The server program S maintains a table free_table of the program counter values in C at which a disk page is freed. Each time S receives a message containing the current program counter value pc and local variables of C, it looks up pc in free_table. If the statement at location pc is a call to free, then S reconstructs from the local variables the address of the page p to be freed. It then marks that page as in server_pool. The resulting server program is shown below:

```
while (true) {
  m = receive();
  pc = m.pc;
  if (alloc_table.lookup(pc))
```

server_pool.mark(m.page_addr);

else if (free_table.lookup(pc))

server_pool.mark(m.page_addr)

}

In a fourth stage of the transformation, the server program S periodically performs the following actions.

1. It removes one or more disk pages from server_pool;

2. It creates a message m whose fields include the address of each disk page removed in Step 1; and

3. It sends m to C.

This transformation permits S to return to C disk pages that were spuriously allocated by C or previously freed by C.

In a fifth stage of the transformation, message transmission statements are added to C. Each message transmission has the form:

send_server(m);

where m is a message containing the current value of C's program counter, and the value of some or all of C's local variables.

In a preferred embodiment, these statements are executed frequently enough that the client cannot distinguish between them and the message transmission statements introduced in the prior transformation stages.

A client monitoring the message traffic between C and S thus cannot easily track which disk pages in client_pool are actually in use, because real free messages cannot be distinguished from fake ones. The message transmission statements introduced in this transformation thus provide steganographic protection for the message transmission statements introduced in the earlier transformations.

In a preferred embodiment, the activities of the client program C are never delayed by waiting for a message from S, so the time needed for the transformed programs C and S to respond to inputs will not be substantially longer than the time needed for the original program P to respond. Because the client cannot determine, by inspecting C, when disk pages are freed, C will eventually run out of disk pages if it is executed without communicating with S.

It is obvious to one skilled in the art that a lazy allocation scheme can be devised for fixed size resources in a manner similar in nature to that of variable sized dynamic memory allocation.

Finally, the server tables must be secured against unauthorized access. It is undesirable to require every server to maintain a long-lived database of malloc, free and other tables for each client. Therefore, a method of co-located client-server programs is described herein as follows that is applicable for distribution of both the client program and server tables (and possibly parts of the server program) to the client site on CD, DVD or other computer readable media, for example. The security of the transformation relies on ensuring that an unauthorized user never obtains access to the server tables. One can achieve this goal by keeping the tables encrypted where the encryption key is known only to authorized servers. The vendor splits the original program into a process and server with an encrypted set of server tables, where the encryption key is known only to the vendor. In order to execute the client, it sends the encrypted tables to a server, where they are decrypted and used by the server until such time as the client completes, when the tables are deleted from the server. Therefore, the server does not need to keep a permanent database of server tables, and yet the scheme is secure because the client never observes the unencrypted server tables.

Described above are methods and systems meeting the desired objects. It will be appreciated that the illustrated embodiment is merely an example of the invention and that other embodiments, incorporating modifications thereto fall within the scope of the invention. Thus, by way of non-limiting example, it will be appreciated that the transformation 103 can be performed with fewer or more transformation stages than those discussed above, and can be performed by a programmer or software engine. Moreover, it may perform those stages serially or concurrently. The transformed resources managed need not be linked to storage resources, but may also be sub-processes that are created (“allocated”) and eliminated (“freed”). Further, it will be appreciated that though the examples are illustrated using the C programming language, the method is applicable for other high-level languages, object, assembly, microcode and any other intermediate instruction set. Still further, it will be appreciated that the mechanisms described above can be used, not only to secure the client program from unauthorized use, access, copying and/or functional analysis, but also to permit control of the client from the server.

In view of the foregoing, what we claim is:

1. A digital data computing method comprising:
executing a process that makes requests and that requires at least asynchronous responses to those requests to continue normal operation;
generating those responses external to the process and supplying them to that process;
the executing step including continuing normal operation of the process when at least asynchronous responses are received to the requests and otherwise discontinuing normal operation such that there is no real-time dependency of that process to those responses.

2. The method of claim 1, comprising performing the executing step on a client and performing the generating step on a server.

3. The method of claim 2, comprising performing the executing step on a server that comprises a secured coprocessor local to the client.

4. The method of claim 2, comprising performing the executing step on a server that is remote with respect to the client.

5. The method of claim 2, comprising performing the executing step utilizing a set of secured instructions and secured memory local to the client, where the instructions and memory are secured either by hardware or software.

6. The method of claim 1, wherein it is computationally difficult to unauthorizedly simulate generation of the responses.

7. The method of claim 6, wherein the executing step includes executing transformed code and wherein it is computationally difficult to determine proper responses to the requests without access to at least a portion of that code prior to a transformation that produces that transformed code.

8. The method of claim 7, comprising performing the transformation automatically.

9. The method of claim 7, comprising performing the transformation manually.

10. The method of claim 1, wherein the generating step includes generating non-deterministic responses to the requests.

11. The method of claim 10, wherein the executing step includes executing transformed code and wherein it is computationally difficult to generate the non-deterministic response without access to at least a portion of that code prior to a transformation that produces that transformed code.

12. The method of claim 1, wherein the executing and generating steps are adapted to securing the generation of responses against any of unauthorized use, access, copying and functional analysis, and of controlling the execution of the process.

13. A digital data computing method securing and controlling a set of instructions (hereafter, “code”) against at least one of unauthorized use, access, copying and functional analysis comprising:
including within the code requests to which the code requires at least asynchronous responses in order to continue normal operation;
generating those responses external to the code and supplying them to that process;
the executing step including continuing normal operation of the process when at least asynchronous responses are received to the requests and otherwise discontinuing normal operation such that there is no real-time dependency of that process to those responses.

14. The method of claim 13, wherein the code is comprised of high-level language or object code or any intermediary level set of computer instructions, or microcode.

15. The method of claim 13, including the step of performing a transformation that includes generating any of code and data upon which the responses are based.

16. The method of claim 15, comprising performing the transformation automatically.

17. The method of claim 15, wherein performing the transformation manually.

18. The method of claim 13, wherein it is computationally difficult to unauthorizedly simulate the generation of proper responses to the requests.

19. The method of claim 18, wherein it is computationally difficult to generate the proper responses without access to at least a portion of code prior to the transformation.

20. The method of claim 13, wherein the generating step includes a non-deterministic action.

21. The method of claim 20, wherein it is computationally difficult to determine the effect of the non-deterministic action without access to at least a portion of the code prior to a transformation that produces that transformed code.

22. The method of claim 15, comprising performing executing the code subsequent to transformation on a client and executing the generating step on a server.

23. The method of claim 22, comprising performing the executing step on a server that comprises secured coprocessor local to the client.

24. The method of claim 22, wherein the server is a remote processor.

25. The method of claim 22, wherein server is comprised of secured instructions utilizing secured memory local to the client, where the instructions and memory are secured either by hardware or software.

26. A digital data computing method, comprising:
executing a computer programming process, the executing step including performing any of allocation and de-allocation of data storage resources; and
providing data necessary for performing such allocation and de-allocation from a source external to the process, wherein that data includes at least one of a size and a location of an area to allocate or de-allocate.

27. The method of claim 26, wherein the executing step includes ceasing normal operation in the absence of such data from the external source within an expected delay interval.

28. The method of claim 26, wherein the executing step includes continuing normal operation in spite of at least expected delay of the data to the process.

29. The method of claim 26, comprising:
performing the executing step on a client;
generating the response data on a server; and
communicating the response data from the server to the client over a packet-switched network, local bus, local interface or other communications medium.

30. The method of claim 29, comprising performing the step of generating the response data on a sever that comprises any of a secured coprocessor and a hardware key.

31. The method of claim 30, wherein the server is a remote processor.

32. The method of claim 30, wherein server is comprised of secured instructions utilizing secured memory, where the instructions and memory are secured either by hardware or software.

33. A digital data computing method for securing and controlling the executing a set of instructions (hereafter, “code”) against at least one of unauthorized use, access, copying and functional analysis comprising:
including, within the code, requests to which the code requires at least asynchronous responses in order to perform allocation and de-allocation of data storages resources;
generating those responses external to the process and supplying them to that process;
continuing normal operation of the code only if at least asynchronous responses are received to the requests and, otherwise, discontinuing normal operation, such that there is no real-time dependency of that code to those responses.

34. The method in claim 33, wherein the executing step includes ceasing normal operation in the absence of such data from the external source within an expected delay interval.

35. The method of claim 33, comprising:
performing the executing step on a client;
generating the response data on a server; and
communicating the response data from the server to the client over a packet-switched network, local bus, local interface or other communications medium.

36. The method of claim 33, wherein the generating step includes a non-deterministic de-allocation action.

37. A digital data computing method, comprising:
executing a computer programming process, the executing step including performing any of allocation and de-allocation of dynamic resources; and
providing data necessary for performing such allocation and de-allocation from a source external to the process, wherein that data includes at least a description of the resource to be allocated or de-allocated.

38. The method of claim 37, wherein the executing step includes ceasing normal operation in the absence of such data from the external source within an expected delay interval.

39. The method of claim 37, wherein the executing step includes continuing normal operation in spite of at least expected delay of the data to the process.

40. The method of claim 37, comprising:
performing the executing step on a client;
generating the response data on a server; and
communicating the response data from the server to the client over a packet-switched network, local bus, local interface or other communications medium.

41. The method of claim 40, comprising performing the step of generating the response data on a server that is any of a coprocessor and a hardware key.

42. The method of claim 40, comprising performing the step of generating the response data on a server that is a remote processor.

43. The method of claim 40, wherein the step of generating the response data includes executing secured instructions utilizing secured memory, where the instructions and memory are secured either by hardware or software.
